(19) United States
(12) Patent Application Publication
(10) Pub. No.: US 2008/0273824 A1
(43) Pub. Date: Nov. 6, 2008

(54) Bearing device for axle and fixing structure using the same

(75) Inventor: Shigeru Inoue, Yokohama-shi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: JTEKT CORPORATION, Osaka (JP)

(21) Appl. No.: 12/010,823

(22) Filed: Jan. 30, 2008

(30) Foreign Application Priority Data
Feb. 1, 2007 (JP) 2007-022648

(51) Int. Cl. F16C 13/02

(52) U.S. Cl. 384/544

(57) ABSTRACT

A bearing device for an axle includes a hub shaft including a flange formed at an outer side portion, and a cylindrical portion formed on an inner side and having a through hole, and a bearing portion including an inner ring, an outer ring, and rolling elements. The bearing portion is press-fitted on the cylindrical portion, and a shaft end portion of the hub shaft is caulked to apply an axial force to the bearing portion. A spacer is interposed between the bearing portion and a caulked portion, and the spacer has a fitting hole fitted on the cylindrical portion, and includes a projecting portion formed at an inner side of an outer periphery, and an inner side end surface of the projecting portion of the spacer is located inwardly of an inner side end surface of the caulked portion in the axial direction.

### BACKGROUND OF THE INVENTION

This invention relates to a bearing device for an axle of an automobile or the like, and a fixing structure using the bearing device.

Conventionally, in a bearing device for a driven wheel of an automobile or the like, a shaft end portion of a hub shaft having a bearing portion mounted thereon is caulked, thereby applying an axial force to the bearing portion before assembling the vehicle. Recently, however, even in a bearing device for a drive wheel, in some cases, a bearing portion is mounted on a hub shaft, and a shaft end portion of the hub shaft is caulked, thereby fixing the bearing portion, and a drive shaft is fitted into the hub shaft, and an abutment surface of the drive shaft is brought into abutting engagement with an end surface of the caulked portion of the hub shaft, and the drive shaft is fixed by fastening means.

In this case, the end surface of the caulked portion of the hub shaft is not always flat, and besides it is difficult to secure precision with respect to perpendicularity and others, and therefore during the rotation of the drive shaft, a relative slip has often developed between the caulked portion of the hub shaft and the abutment surface of the drive shaft, so that a stick-slip sound has been generated.

In order to suppress such a relative slip, it can be proposed to apply a cutting operation to the distal end surface of the caulked portion to thereby enhance the precision. In this case, however, there is a fear that cuttings or chips may intrude into the bearing portion, and therefore this has been found not desirable.

Furthermore, a circumferential stress of an inner ring of the bearing portion increases as a result of caulking the shaft end portion of the hub shaft, so that the inner ring has often been deformed.

There has been proposed a conventional bearing device for a driven wheel, in which a spacer ring made of hardened steel is interposed between an inner ring of a bearing portion and a caulked portion of a shaft end portion of a hub shaft so as to suppress deformation of the inner ring (see, for example, JP-A-2006-52752).

In the axle bearing device in JP-A-2006-52752, the spacer ring is interposed between the inner ring of the bearing portion and the caulked portion of the hub shaft, and therefore the deformation of the inner ring of the bearing portion can be prevented. However, when the structure of this bearing device for the axle is applied to a bearing device for a drive wheel, an abutment surface of a drive shaft abuts against the caulked portion of the hub shaft, and therefore it is difficult to prevent the generation of a stick-slip sound because of the problem with respect to the precision of the end surface of the caulked portion as described above.

### SUMMARY OF THE INVENTION

This invention has been made in order to solve the above problem, and an object of the invention is to provide a bearing device for an axle in which the generation of a stick-slip sound is prevented without being influenced by the precision of an end surface of a caulked portion of a shaft end portion of a hub shaft, and also an inner ring of a bearing portion will not be deformed. The other object is to provide a fixing structure using the bearing device for an axle.

In order to solve the above problem, the present invention provides the following arrangements.

(1) A bearing device for an axle comprising:

a hub shaft that includes a flange to which a wheel is to be mounted and which is formed at an outer side portion of the hub shaft, and a cylindrical portion which is formed on an inner side of the flange and includes a through hole formed through a center portion of the cylindrical portion in an axial direction;

a bearing portion that includes an inner ring, an outer ring, and a plurality of rolling elements disposed between the inner and outer rings, wherein the bearing portion is press-fitted on the cylindrical portion of the hub shaft, and a shaft end portion of the hub shaft is caulked to apply an axial force to the bearing portion;

a spacer that is interposed between the bearing portion and the caulked portion of the shaft end portion, and is formed with a fitting surface fitted on the cylindrical portion of the hub shaft at a center portion of the spacer, and a projecting portion at an axially inner side of an outer periphery of the spacer, wherein an inner side end surface of the projecting portion of the spacer is located inwardly of an inner side end surface of the caulked portion in the axial direction.

(2) The bearing device according to (1), wherein the inner side end surface of the projecting portion of the spacer is formed into a flat surface.
(3) The bearing device according to (1), wherein the spacer is a single piece ring shape member.
(4) The bearing device according to (1), wherein the projecting portion is formed in a ring shape.
(5) A fixing structure comprising:

a bearing device according to (1); and

a drive shaft that includes a body portion having an outer diameter generally equal to an inner diameter of the through hole of the bearing device, and a flange having a diameter larger than an outer diameter of the inner ring and forming an abutment surface provided at an inner side end portion of the body portion, and an externally-threaded portion which is formed at an outer side end portion of the body portion and on which a nut is to be threaded,

wherein the body portion is inserted into the through hole from the inner side of the hub shaft; and the flange of the drive shaft is abutted against the inner side end surface of the projecting portion of the spacer so that the drive shaft is positioned, and

wherein the hub shaft, the inner ring, the spacer and the drive shaft are fixed together in an integral manner.

In the present invention, the spacer having the projecting portion formed at the outer periphery thereof is interposed between the bearing portion press-fitted on the cylindrical portion of the hub shaft and the caulked portion fixing the bearing portion, and the inner side end surface of the projecting portion of the spacer is located inwardly of the inner side end surface of the caulked portion in the axial direction. With this construction, when a drive shaft is mounted in the hub shaft, a flange (an abutment surface) of this drive shaft abuts against the flat end surface of the projecting portion of the spacer, and therefore a stick-slip sound will not be generated during the rotation of the drive shaft, and also the inner ring of the bearing portion will not be deformed, and therefore there can be obtained the axle bearing device having excellent durability and high reliability.

### BRIEF DESCRIPTION OF THE DRAWINGS

FIG. 1 is a longitudinal cross-sectional view of one preferred embodiment of an axle bearing device of the present invention.

FIG. 2A and FIG. 2B are a plan view and a longitudinal cross-sectional view of a spacer of FIG. 1, respectively.

FIG. 3 is a longitudinal cross-sectional view showing a condition in which a drive shaft is mounted in the axle bearing device of FIG. 1.

FIG. 4 is a view explanatory of an important portion of FIG. 3.

### DETAILED DESCRIPTION OF PREFERRED EMBODIMENTS

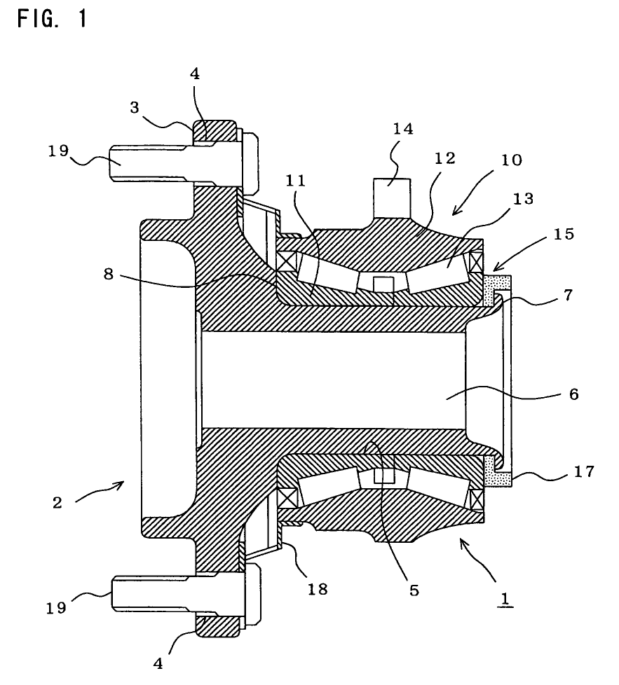

FIG. 1 is a longitudinal cross-sectional view of one preferred embodiment of an axle bearing device of the present invention including a tapered roller bearing. In the following description, a right side in the drawings will be referred to as an inner side, while a left side will be referred to as an outer side.

In the drawings, reference numeral 1 denotes the axle bearing device, and a flange 3 having a plurality of bolt holes 4 is formed on an outer periphery of an outer side portion of a hub shaft 2 made of steel, and bolts 19 are adapted to be press-fitted respectively into the bolt holes 4 so as to fix a wheel (not shown) on the flange 3. A cylindrical portion 5 is formed on and projects from a center portion of the flange 3 toward the inner side, and a bearing portion 10 (described later) is mounted on this cylindrical portion 5. A through hole 6 is formed axially through a center portion of the cylindrical portion 5, and is enlarged in diameter at its inner side end portion, and a drive shaft (described later) is fitted in this through hole 6. A spline is formed on an inner peripheral surface of the through hole 6.

The bearing portion 10 is provided with an inner ring 11 made of steel such as bearing steel, divided in two and having two tapered rolling contact surfaces (raceways) formed on an outer periphery thereof and disposed between ribs formed respectively at opposite ends thereof, an outer ring 12 having two rows of rolling contact surfaces formed on an inner periphery thereof and opposed respectively to the rolling contact surfaces of the inner ring 11, a plurality of (or two rows of) tapered rollers (serving as rolling elements) 13 made of steel such as bearing steel, each row of tapered rollers 13 being disposed between the corresponding rolling contact surfaces of the inner and outer rings 11 and 12, a cage for rollably holding the tapered rollers, grease for lubricating these elements, and a sealing device for sealing a clearance between the outer and inner rings. A flange 14 is formed on the outer periphery of the outer ring 12.

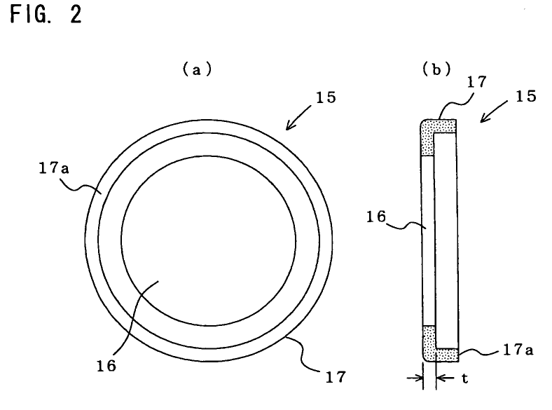

Reference numeral 15 denotes a spacer made of steel, and as best shown in FIG. 2, this spacer 15 has an outer diameter generally equal to an outer diameter of the inner ring 11 of the bearing portion 10, and a fitting hole 16 defining an inner periphery surface which forms a fitting surface for fitting on the cylindrical portion 5 of the hub shaft 2 is formed through a center portion of the spacer 15, and a projecting portion 17 is formed at an outer periphery of the spacer 15, and projects toward the inner side. Thus, the spacer 15 has a generally ring-shape. An inner side end surface 17a of the projecting portion 17 is precisely finished into a flat surface disposed perpendicular to the cylindrical portion 5. Incidentally, although, in the embodiment, the spacer is formed as a single piece ring shape member, the spacer maybe of a split type spacer consisting of plural pieces. For example, plural partial rings may be arranged to contact each other to form the ring shape spacer, and plural partial ring members may be arranged apart from each other to form an intermissive ring shape spacer. Further, although, in the embodiment, the projecting portion is formed in the ring shape, the projecting portion may have various shapes. For example, partial ring portions or column shape portions arranged in a circumferential direction with clearances may be employed. In this embodiment, although a plate thickness t of the spacer 15 is about 4 mm to about 5 mm, it is not limited to this value.

An exterior dust seal 18 is provided between the flange 3 of the hub shaft 2 and the outer ring 12 of the bearing portion 10.

Next, one example of a procedure for assembling the axle bearing device 1 of the above construction will be described.

First, the bearing portion 10 is press-fitted on the outer periphery of the cylindrical portion 5 of the hub shaft 2 from the inner side, and then the fitting hole 16 of the spacer 15 is fitted on the cylindrical portion 5, with the projecting portion 17 directed toward the inner side, and the spacer 15 is brought into abutting engagement with the inner ring 11 of the bearing portion 10. Then, the inner side end portion of the cylindrical portion 5 of the hub shaft 2 is bent radially outwardly and caulked to provide a caulked portion 7. As a result, the inner ring 11 of the bearing portion 10 and the spacer 15 are fixed between the caulked portion 7 and a step portion 8 formed at that portion of the cylindrical portion 5 close to the flange 3 such that an axial force is applied to the inner ring 11 and the spacer 15. At this time, the inner side end surface 17a of the projecting portion 17 of the spacer 15 is located inwardly of an inner side end surface of the caulked portion 7 in the axial direction.

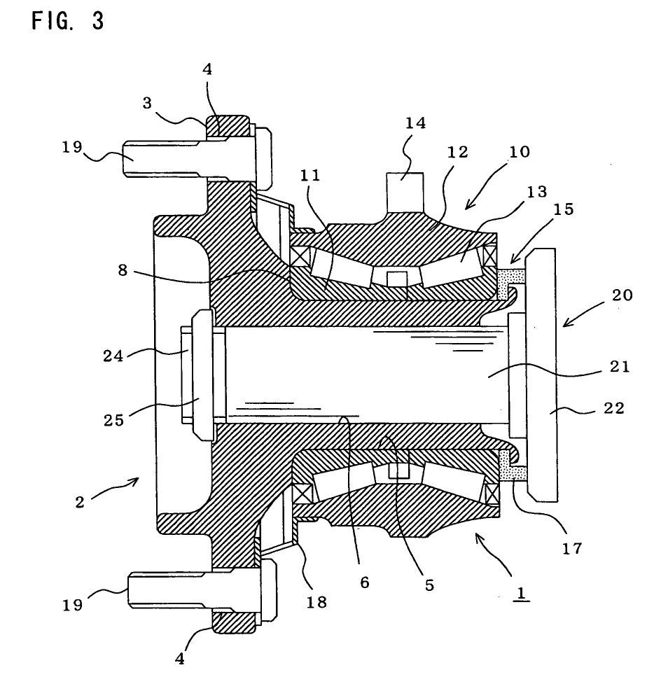

FIG. 3 is a cross-sectional view showing a condition in which the drive shaft is mounted in the axle bearing device 1 of the above construction.

The drive shaft 20 for insertion into the through hole 6 of the hub shaft 2 includes a body portion 21 having an outer diameter generally equal to the inner diameter of the through hole 6, a flange 22 having a diameter larger than the outer diameter of the inner ring 11 and forming an abutment surface provided at an inner side end portion of the body portion 21, and an externally-threaded portion 24 formed at an outer side end portion of the body portion 21, a nut 25 being threaded on the externally-threaded portion 24. In the case where the spline is formed on the inner peripheral surface of the through hole 6 of the hub shaft 2, a spline for fitting to the spline of the through hole 6 are also formed on the body portion 21 of the drive shaft 20.

With respect to the drive shaft 20 of the above construction, the body portion 21 is inserted into the through hole 6 from the inner side of the hub shaft 2, and the flange 22 is brought into abutting engagement with the inner side end surface 17a of the projecting portion 17 of the spacer 15, so that the drive shaft 20 is stopped and positioned. Then, the nut 25 is threaded on the externally-threaded portion 24 of the body portion 21 from the outer side, and is tightened, thereby fixing the hub shaft 2, the inner ring 11 of the bearing portion 10, the spacer 15 and the drive shaft 20 together in an integral manner.

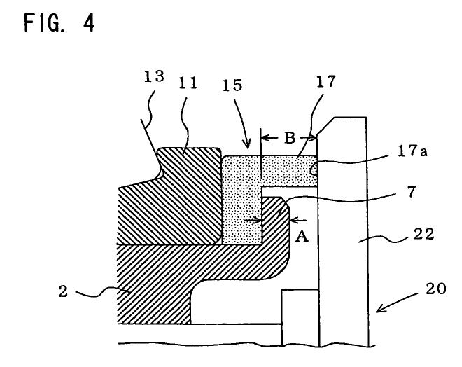

At this time, the flange 22 of the drive shaft 20 abuts against the inner side end surface 17a of the projecting portion 17 of the spacer 17, but will not contact the caulked portion 7 of the hub shaft 2 since the projecting portion 17 projects beyond the inner side end surface of the caulked portion 7, as shown in FIG. 4.

In the present invention, a projecting length A of the projecting portion 17 is larger than a caulking thickness B of the caulked portion 7 (A>B), and in this embodiment although the length A and the thickness B are so determined that (A−B=0.4 to 0.5 mm) is established, the dimensional relation between the two is not limited to this (In FIG. 4, the dimensional relation is shown in an exaggerated manner).

In the axle bearing device 1 having the drive shaft 20 mounted therein, the flange 14 formed at the outer ring 12 of the bearing portion 10 is fixed to an axle case or the like (not shown) against rotation, and the hub shaft 2 (having the drive shaft 20 fixed thereto) and the inner ring 11 of the bearing portion 10 are rotatably supported.

In the above construction of the invention, the spacer 15 having the projecting portion 17 formed at the inner side of the outer periphery thereof is mounted at the inner side of the bearing portion 10 mounted on the cylindrical portion 5 of the hub shaft 2, and the shaft end portion of the hub shaft 20 is caulked through the spacer 15 to thereby fasten the bearing portion 10. Therefore, a circumferential stress of the inner ring 11 of the bearing portion 10 can be suppressed, and besides deformation and cracking of the inner ring 11 due to the fastening by the caulked portion 7 can be prevented.

Furthermore, the projecting length A of the projecting portion 17 of the spacer 15 is larger than the caulking thickness B of the caulked portion 7 (A>B), and also the inner side end surface 17a of the projecting portion 17 is precisely formed into the flat surface, and the flange 22 of the drive shaft 20 is held against this inner side end surface 17a. Therefore, the generation of a stick-slip sound during the rotation of the drive shaft 20 can be prevented.

Furthermore, the flange 22 of the drive shaft 20 does not contact the caulked portion 7, and therefore it is not necessary to process or form the inner side end surface of the caulked portion 7 into a flat surface, and therefore not only this processing step can be omitted, but also cuttings or chips resulting from such a cutting operation will not intrude into the bearing portion 10.

With these advantages, the durability of the axle bearing device 1 is enhanced, so that its reliability can be enhanced.

In the above description, although the present invention is applied to the illustrated axle bearing device, the invention is not limited to this axle bearing device, and can be applied also to other axle bearing devices such for example as a bearing device for an axle using a ball bearing.

In the above embodiment, double row raceway rings of the inner ring are formed separately from the hub shaft. However, the present invention is not limited thereto. For example, one of the double row raceway rings may be formed integrally with the outer peripheral surface of the cylindrical portion of the hub shaft and the other may be formed separately from the hub shaft and fitted to the outer peripheral surface.

What is claimed is:

1. A bearing device for an axle comprising:
a hub shaft that includes a flange to which a wheel is to be mounted and which is formed at an outer side portion of the hub shaft, and a cylindrical portion which is formed on an inner side of the flange and includes a through hole formed through a center portion of the cylindrical portion in an axial direction;
a bearing portion that includes an inner ring, an outer ring, and a plurality of rolling elements disposed between the inner and outer rings, wherein the bearing portion is press-fitted on the cylindrical portion of the hub shaft, and a shaft end portion of the hub shaft is caulked to apply an axial force to the bearing portion;
a spacer that is interposed between the bearing portion and the caulked portion of the shaft end portion, and is formed with a fitting surface fitted on the cylindrical portion of the hub shaft at a center portion of the spacer, and a projecting portion at an axially inner side of an outer periphery of the spacer, wherein an inner side end surface of the projecting portion of the spacer is located inwardly of an inner side end surface of the caulked portion in the axial direction.

2. The bearing device according to claim 1, wherein the inner side end surface of the projecting portion of the spacer is formed into a flat surface.

3. The bearing device according to claim 1, wherein the spacer is a single piece ring shape member.

4. The bearing device according to claim 1, wherein the projecting portion is formed in a ring shape.

5. A fixing structure comprising:
a bearing device according to claim 1; and
a drive shaft that includes a body portion having an outer diameter generally equal to an inner diameter of the through hole of the bearing device, and a flange having a diameter larger than an outer diameter of the inner ring and forming an abutment surface provided at an inner side end portion of the body portion, and an externally-threaded portion which is formed at an outer side end portion of the body portion and on which a nut is to be threaded,
wherein the body portion is inserted into the through hole from the inner side of the hub shaft; and the flange of the drive shaft is abutted against the inner side end surface of the projecting portion of the spacer so that the drive shaft is positioned, and
wherein the hub shaft, the inner ring, the spacer and the drive shaft are fixed together in an integral manner.
